(19) United States
(12) Patent Application Publication
(10) Pub. No.: US 2025/0024816 A1
(43) Pub. Date: Jan. 23, 2025

(54) Leash

(71) Applicants: Maureen Kelly Braga, Boston, MA (US); Harrison Braga, Boston, MA (US)

(72) Inventors: Maureen Kelly Braga, Boston, MA (US); Harrison Braga, Boston, MA (US)

(21) Appl. No.: 18/354,847

(22) Filed: Jul. 19, 2023

(51) Int. Cl. A01K 27/00

(52) U.S. Cl. CPC A01K 27/003

(57) ABSTRACT

A leash having a rigid portion and a flexible portion is provided. The rigid portion of the leash is sized to extend beyond the hind quarters or tail of a dog such that, when hanging free, it remains elevated off the ground adjacent to the dog's feet so as to not get tangled in the dog's feet as is a known problem in the prior art.

### BACKGROUND OF THE INVENTION

The present disclosure relates generally to leash devices. More particularly the present disclosure relates to a leash for a dog and the like which has a rigid distal portion that extends beyond a hind portion of the dog, so as to prevent a tangling of the dog's legs in the leash.

Leashes for dogs and other pets are ubiquitous as a safe and effective way to keep one's dog close, safe, and under control when out in public. Traditional leashes comprise of a connector to connect to a collar, an elongate rope, and a handle at an end. By virtue of the loose rope in combination with a dog's active and somewhat unpredictable movements, it is extremely common for dogs to get their legs tangled amongst the leash, which requires an inconvenient untangling by the person holding the leash.

Therefore, what is needed is a leash device that may efficiently and effectively limit or prevent the leash from getting tangled in the dog's legs.

### SUMMARY OF THE INVENTION

The subject matter of this application may involve, in some cases, interrelated products, alternative solutions to a particular problem, and/or a plurality of different uses of a single system or article.

In one aspect, a leash is provided. The leash is formed of a rigid portion formed of a rod surrounded by a fabric. The rigid portion extends from a distal end of the leash towards the proximal end of the leash. The leash further includes a flexible portion extending from the end of the rigid portion rod to the proximal end of the leash. The distal end of the leash includes a clip while the proximal end of the leash has a handle. In certain aspects, the leash may further comprise a second control handle along a length of the leash. This allows the leash to effectively be shortened, providing more control to the user. Further still, in some aspects the control handle of the leash is positioned at an end of, or along, the rigid portion. This allows improved control as well as allowing for both a pushing on the distal end of the leash rather than just a pulling as in prior art leashes.

### BRIEF DESCRIPTION OF DRAWINGS

FIG. 1 provides an elevation view of an embodiment of the leash.

FIG. 2 provides a cross sectional cutaway view of a rigid portion of the leash.

FIG. 3 provides a view of an embodiment of the leash in use.

FIG. 4 provides a view of another embodiment of the leash in use.

FIG. 5 provides a view of an embodiment of the leash in use.

FIG. 6 provides an elevation view of an embodiment of the leash.

### DETAILED DESCRIPTION OF THE INVENTION

The detailed description set forth below in connection with the appended drawings is intended as a description of presently preferred embodiments of the invention and does not represent the only forms in which the present disclosure may be constructed and/or utilized. The description sets forth the functions and the sequence of steps for constructing and operating the invention in connection with the illustrated embodiments.

Generally, the present disclosure concerns a leash device having a flexible rope portion at a proximal end and a rigid portion at a distal end which connects to a dog or other animal by a connector and collar/harness. The rigid portion comprises an elongate rod formed of, for example ultra-high molecular weight polyethylene which is directly covered by a fabric or rope material. The rigid portion is sized to extend beyond the hind quarters or tail of the dog, so that the dog's foot-fall areas do not go over the leash, but rather the rigid portion hangs freely but elevated by connection to the dog's body. The leash, in many embodiments, further comprises two handles. A first handle at a proximal end of the leash, and a second control handle which connects at or adjacent to a proximal end of the rigid portion of the leash. By placing the control handle at the end of the rigid portion of the leash, superior control over the dog can be achieved allowing for both pushing and pulling motion, and also allowing the rigid portion to be directly elevated to a hand level of the user, even further preventing tangling by the dog's legs.

The leash is formed generally of a fabric or rope structure. In many embodiments, the leash body structure is formed of an elongate material which defines a central opening at, at least, the rigid portion. The rigid material such as the ultra-high molecular weight polyethylene or other stiff material is fitted within the central opening and extends to at or near the distal end of the leash body. A connector as is known in the art may connect to the distal end of the leash. Of course, rigid material may vary, but generally is formed as a stiff and only slightly flexible material such as a hard plastic, wood, composite, and the like. A stitching, barrier, closure, adhesive, and the like may hold the rigid material to or within the covering leash material. In some cases, the rigid material such as a rod may be removable from a pocket or holder formed by the leash. Similarly, the leash may, in many embodiments, be formed of any suitable material. Leash length may vary depending on dog size and user requirements. Generally, the rigid portion of the leash is sized to be longer than a distance from a neck to a hind quarters or tail of a dog. For example, the rigid portion may be approximately 15-40 inches in length, while the flexible portion of the leash may be approximately 10-30 inches in length. In most, but not all embodiments, the rigid portion may be longer than the flexible portion.

While not all embodiments require the second control handle along, on, or adjacent to the rigid portion, it may provide unique advantages when in combination with the rigid portion of the leash. As noted, the rigid portion allows pushing as well as pulling, improving the different ways that the dog can be controlled and guided. In addition, holding the leash at the control handle ensures a rigid and straight connection between the user's hand and the dog, which elevates the leash and prevents any tangling. However, even when holding the leash at its proximal end handle with the flexible portion, or even not holding the leash at all, the rigid portion ensures that it is very difficult for a dog's legs to get over the leash to cause tangling.

The flexible, traditional leash portion, in most embodiments, extends beyond the rigid portion towards a proximal end with a handle a terminal end of the flexible portion. This configuration allows for use and operation as a traditional leash, and allows for a long length of freedom and range for the dog from the user.

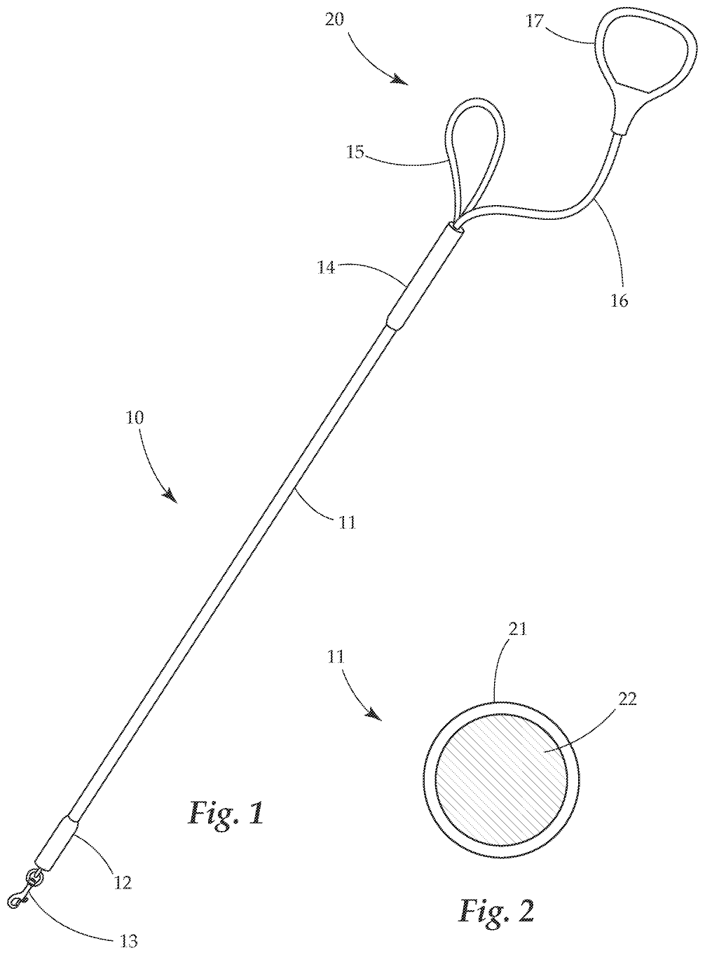

Turning now to FIG. 1, an elevation view of an embodiment of the present disclosure is provided. The leash has a rigid portion 10, and a traditional flexible leash portion 20. A closure 12 secures the clip 13 to the leash rigid portion 10. The rigid portion 10 is formed of a rod 11 which is covered by the leash fabric material. The leash includes two handles 15, 17 in this embodiment. In this view, the control handle 15 is positioned on or directly next to the proximal end of the rigid portion 10. This allows a user to have improved control not only by having the handle closer to the dog, but also by being able to push as well as pull on the leash by way of the rigid portion 10. In one embodiment, the location of the control handle may be adjustable. In addition, the rigid portion 10 is long enough that it extends beyond a hind quarters or tail of the dog, ensuring that it does not get tangled under the dog's feet, even when the leash is free and not being held. The handle 15, in this view, is formed by a loop of leash material which is held in place by wrap 14, though of course other handle formations may be used. The leash flexible portion 20 is formed by a rope 16 or other traditional flexible leash material. Again, the proximal first handle 17 is formed by a loop of leash material which is held in place by wrap 14, though of course other handle formations may be used.

FIG. 2 shows an embodiment of a cutaway view of the rigid portion 11. The stiff but slightly flexible rod, in this embodiment, is encased by a fabric material 21 of the leash which directly contacts the rod and is adjacent to the rod. This simple design allows for ease of manufacture, durability, and versatility of, in some embodiments, having the rod be removable from the leash and/or replaceable/customizable. In certain embodiments, the length of the rod may vary in replaceable versions depending on the size of the dog, while the leash itself may remain the same length. This is particularly useful in embodiments having an adjustable position control handle.

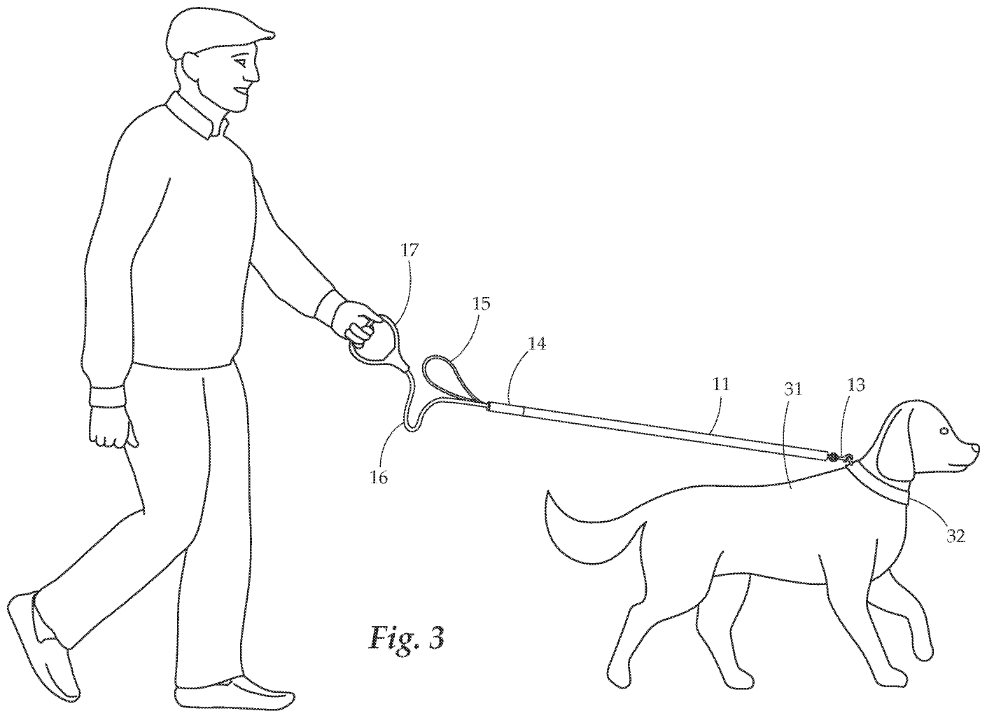

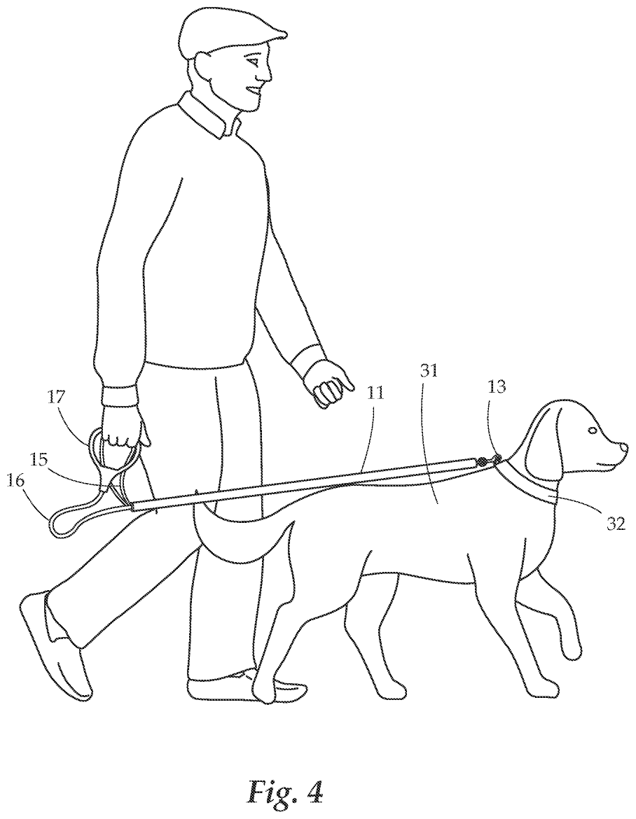

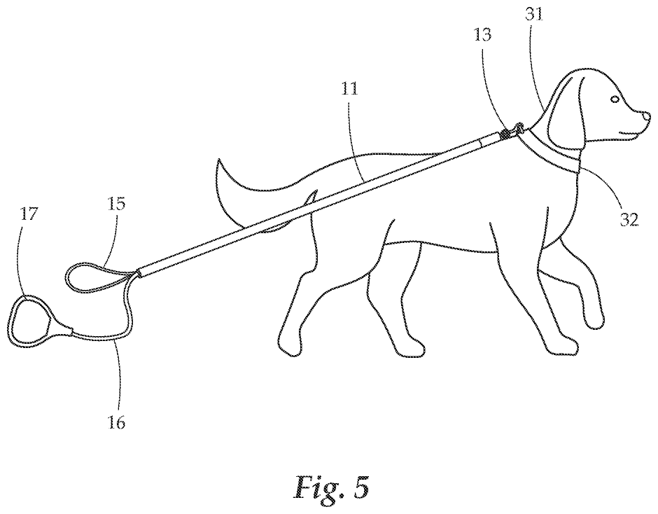

FIGS. 3-5 provide views of an embodiment of the leash of the present disclosure in use. The leash clip 13 is connected to a dog 31 via collar 32. The rod 11 of the rigid portion extends beyond a tail of the dog. As in other embodiments, control handle 15 is formed by wrap 14 at the end of the rigid portion. Leash flexible portion rope 16 extends from the rigid portion and terminates at first handle 17. FIG. 4 provides a view showing how the rigid portion can rest on the back of the dog with both first handle 17 and control handle 15 being held simultaneously. The rigid portion of the leash elevated by the dog's neck or back keeps it off the ground and thus not tangled in the dog's legs. FIG. 5 provides a view of the leash not being held by a user, and as can be seen, the rigid portion rod 11 length extends behind the dog's hind quarters or tail such that the elevated height of the collar raises the entire rigid portion sufficiently off the ground such that the dog's legs do not step over the rod 11, and thus the leash does not get tangled in the dog's legs.

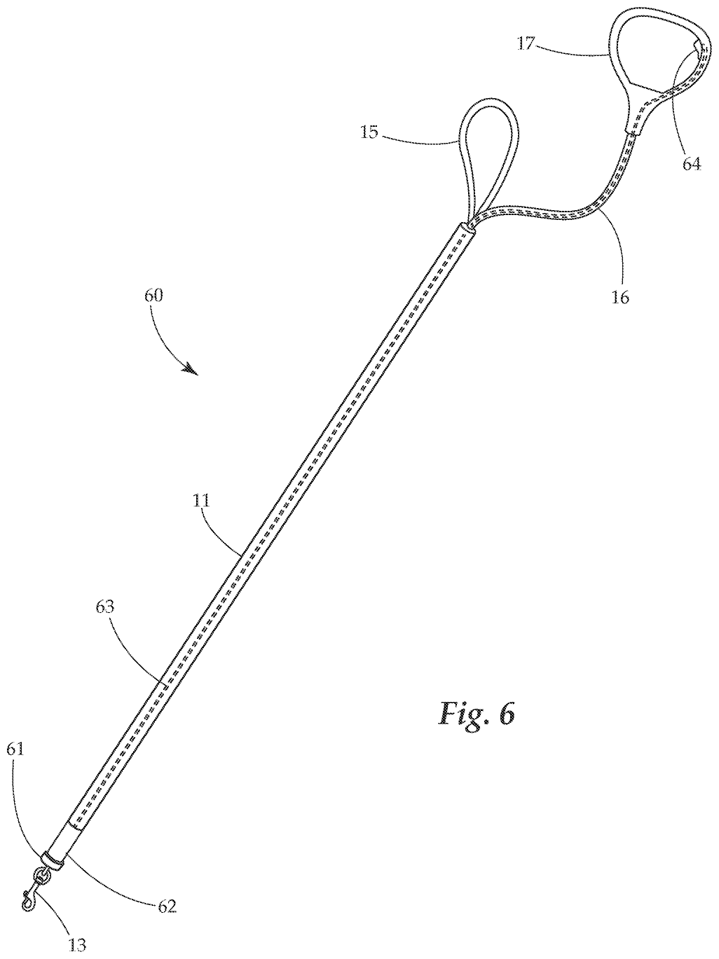

FIG. 6 provides a view of a further embodiment of the present disclosure. In this view, the leash 60 has a rigid portion formed by a rod 11 covered by a fabric or “rope” material such as a nylon. At a distal end of the rigid portion is the clip 13 for hooking to a collar, etc. A vibrator 62 powered by a battery or other power source and motor 61 which spins, in this embodiment, a weight, is positioned between the end of the rod 11 and the clip 13. The vibrator 62 is used for training purposes to provide feedback to the dog. In one embodiment, the rod 11 may be in direct contact with the vibrator 62 such that vibrations are directly conveyed to the rod as well as the clip, increasing the vibrating mass and thus increasing the effect and intensity of the vibrations. Control, such as on/off, vibration pattern, speed, and intensity can be controlled by a control button(s) 64 located, in this embodiment, in the first handle 17, though other locations including control handle 15 may be used as well. The motor 61 is in communication with the control button 64 and the motor is equipped with a plurality of pre-programmed operational settings such as low, medium, high, various vibration patterns, and the like which can result in different vibrations from the vibrator 62 based on motor 61 speed and pattern. A wire 63 extends from the control button(s) 64 to the vibrator motor 61 which allows control of the motor operation and in turn vibrator operation.

In a particular embodiment of the leash having the vibrator of FIG. 6, the rigid portion 10 is comprised of two parts—the elongate rod 11 and the vibrator 62 which is formed in a shape similar to the elongate rod such as a cylinder etc. The vibrator may be directly connected to the rod 11 such as by an adhesive, bracket, snap fit, etc., or integrally formed therewith. In such embodiments, the combination of the two components allows for a shorter rod 11 with the length made up for by the vibrator. For example, instead of the rod being approximately 15-40 inches long, the rod could be 5-30 inches long while the vibrator can be 3-10 inches long.

While several variations of the present disclosure have been illustrated by way of example in preferred or particular embodiments, it is apparent that further embodiments could be developed within the spirit and scope of the present disclosure, or the inventive concept thereof. However, it is to be expressly understood that such modifications and adaptations are within the spirit and scope of the present disclosure, and are inclusive, but not limited to the following appended claims as set forth.

What is claimed is:

1. A leash comprising:
a rigid portion having a rod surrounded by a fabric, the rigid portion extending from a distal end of the leash toward a proximal end;
a clip at the distal end of the leash;
a flexible portion at a proximal end of the leash connected to the rigid portion; and
a handle at a proximal end of the leash.

2. The leash of claim 1 further comprising a second control handle along a length of the leash.

3. The leash of claim 2 wherein the control handle of the leash is positioned at a proximal end of the rigid portion.

4. The leash of claim 1 wherein the control handle is formed of a length of leash material having a free end held in position to the leash by a wrap.

5. The leash of claim 1 wherein the rigid portion is formed by an elongate rod inserted into a pocket defined by the fabric and having the fabric directly in contact with the rod.

6. The leash of claim 5 wherein the elongate rod is formed of an ultra-high molecular weight polyethylene.

7. The leash of claim 1 wherein the rigid portion is between 15-40 inches in length.

8. The leash of claim 1 wherein the flexible portion is between 10-30 inches in length.

9. The leash of claim 1 wherein the rigid portion is longer than the flexible portion.

10. The leash of claim 1 further comprising a collar connected to the leash by the clip.

11. The leash of claim 1 wherein the rigid portion is sized to be longer than a distance from a neck to a hind quarters or tail of a dog.

12. The leash of claim 1 further comprising a vibrator operable to cause a controlled vibration to the clip.

13. The leash of claim 12 wherein the vibrator is positioned at the distal end of the leash.

14. The leash of claim 12 wherein the rigid portion is formed of the rod and the vibrator connected together.

15. The leash of claim 12 further comprising a controller positioned on the handle.

16. The leash of claim 15 further comprising a wire extending between a motor of the vibrator to the controller, the motor being programmed for a plurality of operational modes and controlled by the controller.

17. The leash of claim 12 wherein the vibrator comprises a battery, a motor, and a rotating weight.

18. The leash of claim 14 wherein the elongate rod is directly connected to or integrally formed with the vibrator.

19. The leash of claim 12 further comprising a second control handle along a length of the leash.

20. The leash of claim 19 wherein the control handle of the leash is positioned at a proximal end of the rigid portion.
